(19) United States
(12) Patent Application Publication
(10) Pub. No.: US 2002/0156608 A1
(43) Pub. Date: Oct. 24, 2002

(54) Integrated testcase language for hardware design verification

(75) Inventors: Frank Armbruster, Erfurt (DE); Stefan Koerner, Leinfelden-Echterdingen (DE); Karin Rebmann, Holzgerlingen (DE)

Correspondence Address: IBM Corporation, Intellectual Property Law, 2455 South Road, P386, Poughkeepsie, NY, 12601, US

(73) Assignee: International Business Machines Corporation, Armonk, NY

(21) Appl. No.: 10/125,308

(22) Filed: Apr. 17, 2002

(30) Foreign Application Priority Data
Apr. 18, 2001 (EP) 01109564.3

(51) Int. Cl. G06F 17/50

(52) U.S. Cl. 703/14

(57) ABSTRACT

The present invention relates to hardware design and simulation thereof. In particular, it relates to a method and system for verifying hardware designs. It is basically proposed to provide a plurality of instruments, i.e., a kind of testcase language, which is able to simplify the hardware verification work. Each of the language elements contributes specifically to the general aim of the present invention, i.e., to improve the management of test cases and their execution. For example, a construct language element is provided which is able to be filled up with technical information about one or more hardware logic functions, and which checks their functionality by its own, returning an error value. Thus, the advantage results that due to the systematic management of testcases an efficient testcase generation and execution can be performed.

### BACKGROUND OF THE INVENTION

The present invention relates to hardware design and simulation thereof. In particular, it relates to a method and system for verifying hardware designs in which an executable model file is built reflecting the logic of the hardware design under examination and in which the hardware design is simulated by executing the model execution file with a plurality of so-called test cases.

Said methods are generally in use for simulating hardware logic designs which have some system control function and which are below the so-called architectural level. Said system logic functions are often referred to in prior art as ‘pervasive logic’.

Such pervasive logic must be verified like other hardware. However, said pervasive logic has to fulfill many different functions which can hardly be checked in a random environment. Thus, prior art verification methods use a plurality of so-called test cases which verify each function and validate the result.

In regard of the complexity of hardware circuits to be simulated the management of such test cases is difficult. In order to set up useful test cases which are theoretically adapted to yield hardware verification results which are significant for a given hardware simulation situation, a test case has to reflect many different things. The given design model represents a kind of state machine having a very large multiplicity of locations at which specific states are expected to emerge when certain boundary conditions are given.

Further, any state behavior may change after looping through a given number of cycles.

Further, a significant extent of hardware knowledge is required to know about the expected state values at a given location in the chip, either an input/output location or somewhere within the wires of the chip. In order to create good test cases the complex information resulting from any simulation run must be present in a clear, easy-to-understand form.

Prior art systems do not provide such an advantageous form. Instead, the staff must manually evaluate a large number of test cases, has to set up a kind of ordering plan which is maybe able—but maybe not—to clear up the complexity of the test case results in order to be able to generate useful new test cases. Otherwise, a given hardware is not sufficiently checked.

### SUMMARY OF THE INVENTION

It is thus an object of the present invention to provide a method which alleviates the above mentioned problems of test case complexity and disorder.

According to its primary aspect, the intentional method for verifying hardware designs comprises the following steps of using an executable model file reflecting the logic of the hardware design and simulating the hardware design by executing the model execution file with a plurality of test cases. The intentional method is characterized by the steps of:

a. using a test language for systematically managing said testcases, and

b. feeding a testcase interpreter with said testcases, whereby the interpreter is used as an interface to said executable model file to be run in a simulator program.

Thus, the present invention comprises basically to provide a plurality of instruments, i.e., said before-mentioned testcase language, which are able to simplify the hardware verification work. Said instruments are represented by the different language elements which are described in more detail later below. Each of said language elements contributes specifically to the general aim of the present invention, i.e., to improve the management of test cases and their execution.

Thus, the advantage results that, due to the systematic management of testcases, an efficient testcase generation and execution can be performed.

In particular, when the testcase language comprises a so-called construct language element which is able to be filled up with technical information about one or more hardware logic functions, and which checks their functionality by its own, returning an error value, then a further specific advantage is achieved:

Said construct language element provides a facility to encapsulate all information required to test a particular hardware function which is to be analyzed and verified into one test case entry. Thus, the staff developing test cases is not required to specify a plurality of, e.g., 100 single steps for setting up a specific test case entry, but instead, said work can be done once and then be stored in said CONSTRUCT element in order to be simply associated with one or more test cases. This enables the staff to organize the verification work in a more systematic form which helps to avoid verification gaps.

Herefrom the advantage results that the complexity of a given hardware, and in particular non-archtitectural system control hardware can be easier understood by the staff and thus the verification work becomes more efficient and reliable.

By applying high-level program language commands, preferably IF, WHILE, DO, BRANCH, LOOP, etc., specifically desired testcase situations may be built-up. Thus, those commands may be used for coupling said construct elements with each other, e.g., by generating a LOOP over a particular construct X, IF any condition is met.

Further, when generating a two-part result report in which one part comprises a rough summary of results, and the other part comprises details associated with respective details of a single testcase, a large number of simulation results can be viewed quickly—and whenever necessary—error results can be efficiently viewed for further analysis.

Further, when providing regression packages in which preferably all testcases or subgroups of them are collected for a given hardware design, then a list of possibly 1000 or more testcases can be set up and be invoked for a simulation run with a single command. Thus, this is a step forward to avoid to forget testcases, for example after a model modification was performed which has to be simulated again, with the same or even an extended testcase list.

Further, either of the following features contributes to an advantageous embodiment of the testcase language:

A CHECK feature is advantageously implemented as a software interface arranged for evaluating or checking the construct result values. Thus, it advantageously issues a signal status of any logic facility which is present in the simulation model. It can thus be used for providing a detailed control of any specific signal in order to check each single respective logic element of the design. In addition to the CHECK feature many single executed constructs in the simulation mode return a specific result which can be viewed after simulation.

The SUBPROGRAM command can be advantageously used for realizing a reuse of code, for example in situations in which a plurality of different test cases always need the same well-defined startup status. Here, a subprogram may comprise all constructs which are needed to generate a particular desired status of signals at a certain point in time and at a plurality of desired logic facilities in the simulation model or which define boundary conditions like a clocked or a non-clocked simulation, or the like.

Further, the before-mentioned construct and command language elements can be invoked with one or more parameters, e.g., facility names or addresses, etc. Thus, this feature can be advantageously used in situations in which one and the same test case should be run with the plurality of different control parameters. Thus, each of the parameters in a parameter list associated with a given test case yields a specific test case result. The advantage is that via such parameters a kind of test case reuse can be realized which avoids to repeatedly entering the same test case each with respective modified control parameters. Thus, the test case generation and the test case results are significantly easier to be understood by the staff.

A randomly generated input for the model is advantageously applicable for specifying random control input for a single logic facility.

### BRIEF DESCRIPTION OF THE DRAWINGS

These and other objects will be apparent to one skilled in the art from the following detailed description of the invention taken in conjunction with the accompanying drawings in which:

FIG. 1 is a schematic block diagram representation illustrating the most essential components used within verification, according to prior art (right side), according to the invention (additionally left part); and

FIG. 2 is a schematic representation of a control flow comprising the steps done when verifying hardware designs according to the invention.

### DESCRIPTION OF THE PREFERRED EMBODIMENT

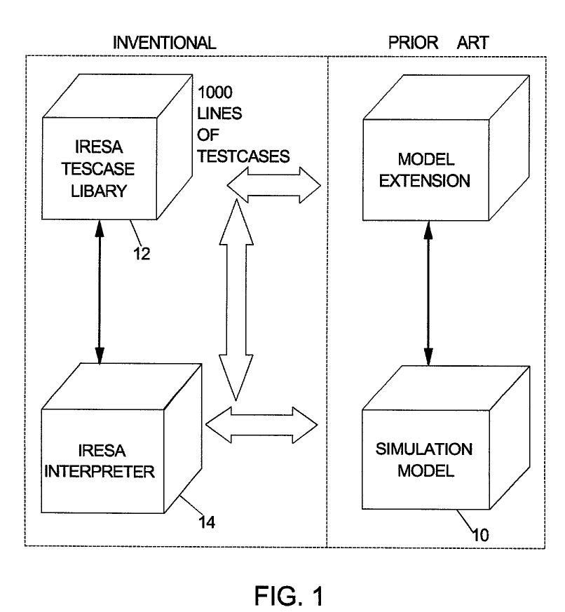

With general reference to the figures and with special reference now to FIG. 1, a structural overview is given over the components used in the present invention. A disclosed test case library 12 comprises the plurality of test cases for a given hardware design of which the associated executable simulation model file exists. It should be noted that a test case may, for example, comprise about 1000 lines of code, and the library may comprise about 1000 test cases. Thus, a considerable number of lines of code must be computed when the testcases are simulated in a simulation run.

An interpreter component 14 is also involved as an intermediate interface means between said library 12 and the simulation model 10, and so-called model extensions 13, as they exist in prior art as well.

It should be further noted that the disclosed components 12 and 14 are able to cooperate with any prior art software simulator supporting an appropriate API. The API eases the access to the simulation model 10.

As it reveals already from the name, the main task of the interpreter component 14 is to resolve the disclosed constructs and commands and issues a respective number of actions subcommands to the simulation model 10.

Particular exemplary constructs are language elements like, e.g.,

RANDOM, which enables the model to be stimulated randomly,

CHAIN COMPARE, which enables for comparing the statuses of a sequence, i.e., a chain of e.g., latches,

COMPARE SIGNAL, which enables for comparing a signal with one or more others signals,

SHIFT CHAIN, which allows for shifting chains,

ACTIVATE, which allows for activating particular constructs, testcases, or other language elements,

GENERATE SHIFT PULSES for generating shift pulses, etc.

Particular, exemplary commands are:

IF /THEN/ ELSE,

LOOP,

WHILE,

BRANCH (i.e., in sense of an unconditioned GOTO),

CALL for invoking a construct, or other piece of code,

SIM for invoking the simulator program,

VARIABLE, for defining any required additional variable, may be for storing evaluation results or any other information, or others.

Further, when the execution generates result output, the interpreter takes over this output data and generates, for example, the preferred result files in either the compressed and the detailed form as it was mentioned above.

Model extensions 13 stimulate the simulation model 10 on interfaces that are not modeled completely. They extend the simulation model with a specific interface aspect. The interpreter is able to set up the model extensions depending on the model behavior that shall be verified.

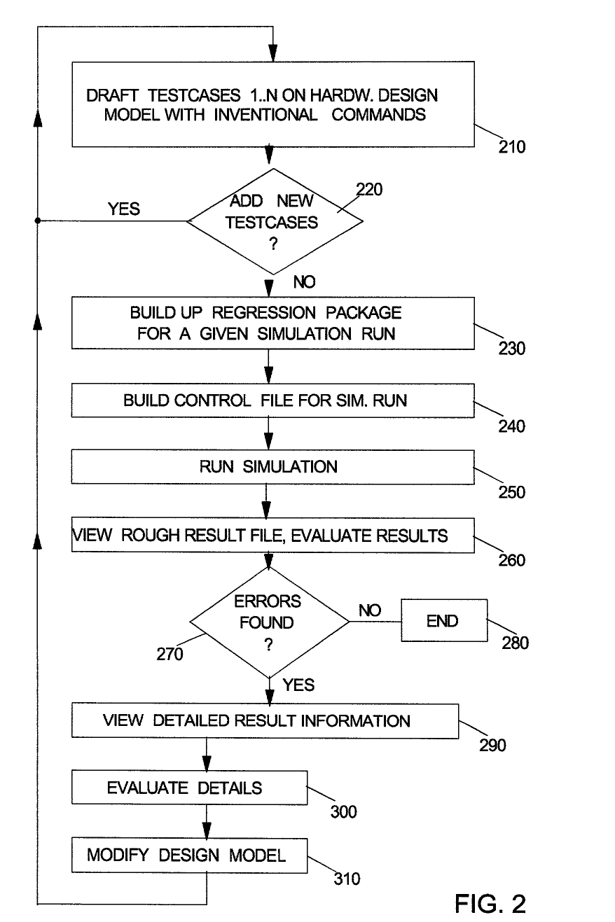

With reference now to FIG. 2, a schematic overview diagram illustrating the control flow when the disclosed embodiment is applied, will be described next below.

This is done in a situation in which some simulation model exists which represents a hardware logic design of some system control hardware as it was set out above. Thus, preferably a non-architectural hardware is represented in the respective simulation model file.

In a first step 210 a number of test cases 1 . . . N is drafted related with said hardware design model by aid of the disclosed commands and constructs mentioned above. Thus, in particular a construct is applied in order to comprise special sequences in the simulation model representing a focus of analysis and giving each back a return value during simulation from which an error can be decoded. And further, any of the above mentioned commands can be used for creating a specific desired testcase scenario.

This can simply be done with those construct and command language elements because on the one hand, a construct performs interactions with the underlying hardware model, whereas a command is usable for adapting a testcase to the desired verification situation, as well as to adapt a large plurality of testcases in order to form a useful testcase sequence—useful for generating significant test results covering one or more points focus in the underlying hardware design in simulation.

Then, in a next step 220 a decision is met stating if further test cases are required or not, in order to complete the input for an intended simulation run. In the yes-branch, it is simply branched back to step 210 in order to draft respective new test cases. Else, one or more regression packages are built up by taking a respective quantity of testcases into the package, naming the package with a unique name, step 230, such that a complete regression package can be taken as a whole for input into the simulation run.

Then, in a step 240 a control file is built up which specifies said package name—or in case of more than one package, all package names—in order to have an easy-to-use start of the simulation run.

Said simulation is now started in a step 250. After a while, for example over night, the simulation will have completed. Then, in a step 260, the result files can be viewed. Preferably, this work will begin with viewing the rough result files, i.e., the result files which comprise the simulation results in a compressed form. Preferably, said compressed form can be extremely compressed by expressing the result as error-free thus yielding for example a value of 0, or else as having some error and thus yielding a result value of 1, step 260.

Preferably, when an error is found the respective testcase result can be viewed in detail form, step 270, 290 by opening the corresponding detailed result file which is able to be identified via a unique name. Thus, a person skilled in the art and member of the staff can evaluate the result details, step 300 and give respective proposals for modifications to be undertaken by someone who cares about the respective, underlying model execution file. Then, after a respective modification of the design model, step 310, which is responsive to said result data evaluation a new loop cycle can be undertaken by branching back to step 210. In most cases, new test cases are added then and are input preferably into the same regression package which was used before.

If, however, the compressed results yield that no errors were found, the control flow may end, or alternatively, may branch also back to step 210 in order to extend the number of test cases in order to increase the verification quality.

Thus, due to its systematic nature, the present invention represents a large step forward of increased quality and efficiency in design verification.

In the foregoing specification, the invention has been described with reference to a specific exemplary embodiment thereof. It will, however, be evident that various modifications and changes may be made thereto without departing from the broader spirit and scope of the invention as set forth in the appended claims. The specification and drawings are accordingly to be regarded as illustrative rather than in a restrictive sense.

It should be understood by a person skilled in the art that the above specified names for interpreter commands and constructs do not restrict the scope of the present invention. Further, some of them might be missing while already increasing the verification quality by a considerable step.

Further, the programming language used for implementing the commands and constructs is not restricted to any specific one.

The present invention can be realized in hardware, software, or a combination of hardware and software. A testcase management tool according to the present invention can be realized in a centralized fashion in one computer system, or in a distributed fashion where different elements are spread across several interconnected computer systems. Any kind of computer system or other apparatus adapted for carrying out the methods described herein is suitable. A typical combination of hardware and software could be a general purpose computer system with a computer program that, when being loaded and executed, controls the computer system such that it carries out the client or server specific steps of the methods described herein.

The present invention can also be embedded in a computer program product, which comprises all the features enabling the implementation the respective steps of the methods described herein, and which—when loaded in one or more computer systems—is able to carry out these methods.

Computer program means or computer program in the present context mean any expression, in any language, code or notation, of a set of instructions intended to cause a system having an information processing capability to perform a particular function either directly or after either or both of the following:

a) conversion to another language, code or notation;

b) reproduction in a different material form.

While the preferred embodiment of the invention has been illustrated and described herein, it is to be understood that the invention is not limited to the precise construction herein disclosed, and the right is reserved to all changes and modifications coming within the scope of the invention as defined in the appended claims.

What is claimed is:

1. A method for verifying hardware designs comprising the steps of:
using an executable model file reflecting the logic of the hardware design, and
simulating the hardware design by executing the model execution file with a plurality of testcases, wherein said simulating comprises:
a. using a testcase language for systematically managing said testcases, and
b. feeding a testcase interpreter with said testcases, whereby the interpreter is used as an interface to said executable model file to be run in a simulator program.

2. The method according to claim 1 in which the testcase language comprises a construct language element which is able to be filled up with technical information about hardware design properties, and with programming specific contents.

3. The method according to claim 1 further comprising the step of generating a two-part result report in which one part comprises a compressed result information, and the other part comprises detailed result information associated with respective details of a single testcase.

4. The method according to claim 1 further comprising the step of providing regression packages in which all testcases or subgroups of testcases are collected for a given hardware design.

5. The method according to claim 1 further comprising one or more of the following steps of:
verifying the results of one or more executed constructs,
reusing code portions building lists comprising one or more parameters for checking a single test with a respective plurality of instantiations setup by a respective parameter list, and
generating random input for the model.

6. The method according to claim 5 further comprising simulating non-architectural logic designs, in particular system control hardware.

7. A system for verifying hardware designs comprising:
an executable model file reflecting the logic of the hardware design, and
program code simulating the hardware design by executing the model execution file with a plurality of testcases, said program code comprising:
a. a testcase language for systematically managing said testcases, and
b. a testcase interpreter with said testcases, whereby the interpreter is used as an interface to said executable model file to be run in a simulator program.

8. The system according to claim 7 in which the testcase language comprises a construct language element which is able to be filled up with technical information about hardware design properties, and with programming specific contents.

9. The system according to claim 7 further comprising program code generating a two-part result report in which one part comprises a compressed result information, and the other part comprises detailed result information associated with respective details of a single testcase.

10. The system according to claim 7 further comprising regression packages in which all testcases or subgroups of testcases are collected for a given hardware design.

11. The system according to claim 7 further comprising one or more of:
program code verifying the results of one or more executed constructs,
code portions building lists comprising one or more parameters for checking a single test with a respective plurality of instantiations setup by a respective parameter list, and
program code generating random input for the model.

12. The system according to claim 11 further comprising program code simulating non-architectural logic designs, in particular system control hardware.

13. A program product for verifying hardware designs comprising:
a computer readable medium having recorded thereon computer readable program code performing the method comprising the steps of:
using an executable model file reflecting the logic of the hardware design, and
simulating the hardware design by executing the model execution file with a plurality of testcases, wherein said simulating comprises:
a. using a testcase language for systematically managing said testcases, and
b. feeding a testcase interpreter with said testcases, whereby the interpreter is used as an interface to said executable model file to be run in a simulator program.

14. The program product according to claim 13 in which the testcase language comprises a construct language element which is able to be filled up with technical information about hardware design properties, and with programming specific contents.

15. The program product according to claim 13 wherein the method further comprises the step of generating a two-part result report in which one part comprises a compressed result information, and the other part comprises detailed result information associated with respective details of a single testcase.

16. The program product according to claim 13 wherein the method further comprises the step of providing regression packages in which all testcases or subgroups of testcases are collected for a given hardware design.

17. The program product according to claim 13 wherein the method further comprises one or more of the following steps of:
verifying the results of one or more executed constructs,
reusing code portions building lists comprising one or more parameters for checking a single test with a respective plurality of instantiations setup by a respective parameter list, and
generating random input for the model.

18. The program product according to claim 17 wherein the method further comprises simulating non-architectural logic designs, in particular system control hardware.
